(19) United States
(12) Patent Application Publication
(10) Pub. No.: US 2026/0322506 A1
(43) Pub. Date: Oct. 15, 2026

(54) UNDERWATER ACOUSTIC COMMUNICATION DEVICE HAVING WIRELESS ENERGY HARVESTING FUNCTION, AND UNDERWATER ACOUSTIC COMMUNICATION METHOD

(71) Applicant: SOUTH CHINA UNIVERSITY OF TECHNOLOGY, Guangzhou City (CN)

(72) Inventors: Yizhi Feng, Guangzhou City (CN); Ronglin Xing, Guangzhou City (CN)

(21) Appl. No.: 19/491,557

(22) PCT Filed: May 27, 2024
(86) PCT No.: PCT/CN2024/095619

§ 371 Date: Dec. 9, 2025

(30) Foreign Application Priority Data
Jun. 9, 2023 (CN) 202310682612.2

(51) Int. Cl. H04B 13/02; H02J 50/00; H02M 1/00

(52) U.S. Cl. CPC H04B 13/02; H02J 50/001; H02M 1/009

(57) ABSTRACT

Disclosed in the present invention are an underwater acoustic communication device having a wireless energy harvesting function, and an underwater acoustic communication method. The underwater acoustic communication device is composed of a hydrophone, an on-duty circuit module, a received information processing module, an energy harvesting module, an energy storage module, a single-chip microcomputer minimum system, a data storage unit, a transmit information processing module, a power amplifier module, an impedance matching circuit, a loudspeaker, a sensor, and an interface. According to the underwater acoustic communication device having the wireless energy harvesting function in the present invention, vibration energy caused by acoustic waves in a water body can be converted into electrical energy, and the electrical energy is stored in the energy storage module, so that energy is provided for all the low-energy-consumption modules in the device, the service life of a power supply of the whole underwater acoustic communication device can be prolonged, and the frequency of battery recycling can be reduced. The device can also receive and decode useful signals, and report anomaly data to a target node when the sensor collects the anomaly data, and is suitable for long-time underwater operation.

### FIELD OF THE INVENTION

The present disclosure relates to the technical field of underwater acoustic communication, and in particular, to an underwater acoustic communication device having a wireless energy harvesting function, and an underwater acoustic communication method.

### BACKGROUND OF THE INVENTION

With the deepening of human exploration of the ocean, underwater acoustic communication technology has been widely applied in military and civilian fields. Due to the industry's increasing demands for communication distance and communication quality, the power consumption of underwater acoustic communication devices has correspondingly increased, which poses a severe challenge to the size and service life of device batteries, requiring frequent battery replacement to maintain normal underwater operation. Wireless energy harvesting technology is regarded as a method to extend the operating duration of underwater devices and reduce the frequency of battery recycling. However, most existing underwater devices lack the capability to simultaneously harvest wireless energy and receive/send signals. Therefore, how to design an underwater acoustic communication device having a wireless energy harvesting function and a suitable operating method is a technical problem to be solved.

### SUMMARY OF THE INVENTION

An object of the present disclosure is to solve the foregoing defects in the related art by providing an underwater acoustic communication device having a wireless energy harvesting function, and an underwater acoustic communication method.

A first object of the present disclosure may be achieved by the following technical solutions.

An underwater acoustic communication device having a wireless energy harvesting function is provided, including: a sensor, a data storage unit, a receiving transducer, a transmitting transducer, an on-duty circuit module, an energy harvesting module, an energy storage module, a received information processing module, a minimum microcontroller system, a transmit information processing module, a power amplifier module, an impedance matching circuit, and an interface, the receiving transducer and the transmitting transducer being referred to as a hydrophone and a loudspeaker hereinafter, respectively;
the sensor collects environmental data and outputs the environmental data to the minimum microcontroller system;
the data storage unit is connected to the minimum microcontroller system for data storage and exchange;
the hydrophone collects external environmental signals and transmits the external environmental signals to the on-duty circuit module, and the on-duty circuit module is connected to the minimum microcontroller system;
the on-duty circuit module receives the signals from the hydrophone, cooperates with the minimum microcontroller system to perform frequency determination and channel selection on the signals, and outputs the signals to the energy harvesting module or the received information processing module;
the energy harvesting module receives the signals from the on-duty circuit module, rectifies and boosts the signals to obtain a high DC voltage, and outputs the high DC voltage to the energy storage module;
the energy storage module receives the high DC voltage from the energy harvesting module, stores electrical energy, and is connected to the sensor, the on-duty circuit module, the received information processing module, the minimum microcontroller system, the transmit information processing module, and the power amplifier module to provide operating voltages;
the received information processing module receives the signals from the on-duty circuit module, performs gain amplification and filtering on the signals, and then outputs the signals to the minimum microcontroller system;
the minimum microcontroller system is connected to the sensor to receive the environmental data, is connected to the data storage unit for data storage and exchange, is connected to the on-duty circuit module to participate in frequency determination and channel selection of the signals, receives the signals from the received information processing module and performs demodulation and analog-to-digital conversion to interpret information, and is connected to the transmit information processing module;
the transmit information processing module receives a drive signal and a wake-up signal from the minimum microcontroller system, generates a designated transmit signal, and outputs the signal to the power amplifier module;
the power amplifier module receives the signal from the transmit information processing module, performs power amplification and filtering on the signal, and outputs the signal to the impedance matching circuit;
the impedance matching circuit receives the transmit signal from the power amplifier module, adjusts the output impedance of the power amplifier module, eliminates a capacitive component, reduces reactive power loss, achieves optimal power transmission matching with the loudspeaker, and outputs the signal to the loudspeaker;
the loudspeaker is configured to transmit the signal into an external underwater acoustic environment;
the interface is configured to download the data stored in the data storage unit or program the minimum microcontroller system.

Further, the on-duty circuit module includes a voltage comparator and a relay. One end of the voltage comparator receives the signal from the hydrophone, and the other end of the voltage comparator is set with a fixed voltage as a reference voltage. When a received signal voltage value is greater than a reference voltage value, the output is a high level; otherwise, it is a low level, thereby realizing the conversion from a sine wave to a square wave, and facilitating the minimum microcontroller system in detecting the signal frequency.

The minimum microcontroller system receives the signal from the voltage comparator and detects the number of transitions of the square wave within a certain period using a capture function of a timer, thereby determining the signal frequency. When it is detected that the signal frequency is the target frequency, the minimum microcontroller system sends an enable signal to the relay and a wake-up signal to the received information processing module. When it is detected that the signal frequency does not match the target frequency, the minimum microcontroller system does not send signals to other modules.

The relay receives the signal from the hydrophone and the enable signal from the minimum microcontroller system. When the enable signal is received, the relay closes and outputs the signal from the hydrophone to the received information processing module. When no enable signal is received, the relay opens and outputs the signal from the hydrophone to the energy harvesting module.

The design of the on-duty circuit module enables the device to distinguish the types of signals received by the hydrophone through frequency, which is the key to the wireless energy harvesting of the underwater acoustic communication device.

Further, the received information processing module includes an automatic gain amplification circuit, a filter circuit, and a voltage follower.

The automatic gain amplification circuit receives the signal from the on-duty circuit module. Its core chip can automatically adjust the gain according to the control voltage, forming a linear relationship within a certain range. It performs amplitude limiting on a signal with a large voltage amplitude and amplifies a signal with a small voltage amplitude, thereby achieving the purpose of adjusting different amplitudes of the received signals to a fixed value. Then, it outputs the signal to the filter circuit.

The filter circuit receives the signal from the automatic gain amplification circuit and filters out noise interference of other frequency components using a band-pass filter, which helps ensure effective processing of the signal by the system. Then, it outputs the signal to the voltage follower.

The voltage follower receives the signal from the filter circuit. The voltage follower uses an operational amplifier as the core, adjusts the matching resistance to make the output signal voltage amplitude approximately equal to the input signal voltage amplitude, and outputs the signal to the minimum microcontroller system. The voltage follower has the characteristics of high input impedance and low output impedance and acts as a buffer circuit or an isolation circuit.

Further, the energy harvesting module includes a rectifier circuit and a boost circuit.

The rectifier circuit receives the signal from the on-duty circuit module. Since charging an energy storage medium requires DC electrical energy instead of AC electrical energy, the rectifier circuit uses two diodes and a filter capacitor to convert the AC electrical energy into the DC electrical energy, and outputs the DC electrical energy to the boost circuit.

The boost circuit receives the DC electrical energy from the rectifier circuit. In this case, a voltage value of the DC electrical energy is low and cannot charge the energy storage medium. Therefore, the boost circuit uses the chip to raise a low DC voltage to a high DC voltage suitable for charging the subsequent energy storage medium, and outputs the high DC voltage to the energy storage module.

Further, the energy storage module includes an energy storage medium and a voltage transformation circuit.

The energy storage medium usually uses a lithium battery. The DC electrical energy of a certain amplitude from the boost circuit may charge the lithium battery, and the lithium battery is connected to an input end of the voltage transformation circuit.

The voltage transformation circuit receives energy from the energy storage medium, including a 3.7 V-to-5 V circuit, a +5 V-to-−5 V circuit, and a +5 V-to-+3.3 V circuit, which are implemented with three different chips as the core. After voltage transformation, the signal is transmitted to the sensor, the on-duty circuit module, the received information processing module, the minimum microcontroller system, the transmit information processing module, and the power amplifier module to provide the operating voltages.

Further, the transmit information processing module includes a signal generation sub-module and a filter sub-module. The signal generation sub-module receives the drive signal and the data from the minimum microcontroller system, uses a DDS chip to generate smooth, high-precision, and high-resolution sine wave signals of different frequencies, and outputs the signals to the filter sub-module. In addition, the DDS chip receives the wake-up signal from the minimum microcontroller system, and only enters an operating state after receiving the wake-up signal, thereby saving device energy consumption.

The filter sub-module receives the signals from the signal generation sub-module, performs all-pass filtering on the signals to improve the frequency response of the signals, and outputs the signals to the power amplifier module.

Further, the power amplifier module includes a pre-amplification sub-module, a power amplification sub-module, and a low-pass filter sub-module.

The pre-amplification sub-module includes a chip and a peripheral circuit, and the amplification factor of the input signal is determined by adjusting the resistance value in the peripheral circuit. Since the power amplification sub-module has certain requirements for the amplitude of the input signal, and the amplitude of the signal outputted by the signal generation sub-module cannot be changed. Therefore, the pre-amplification sub-module receives the signal from the filter sub-module, amplifies the signal amplitude to a certain value, and outputs the signal to the power amplification sub-module.

The power amplification sub-module adopts a class D power amplifier. The class D power amplifier includes a chip and its peripheral circuit. The adjustment of a self-oscillating circuit, a bootstrap circuit, and a feedback resistor determines the voltage gain of the power amplification sub-module. The power amplification sub-module receives the signal from the pre-amplification sub-module, amplifies the signal power, obtains a PWM signal, and outputs the PWM signal to the low-pass filter sub-module.

The low-pass filter sub-module receives the PWM signal from the power amplification sub-module, reconstructs the signal into an analog signal through an LC low-pass filter, and outputs the analog signal to the impedance matching circuit.

Further, the impedance matching circuit includes a tuning matcher and a transformer matcher.

The tuning matcher receives the signal from the low-pass filter sub-module, eliminates the capacitive component of the input impedance of the loudspeaker using an inductor, which can reduce the reactive power consumption of the device, and then outputs the signal to the transformer matcher.

The transformer matcher receives the signal from the tuning matcher, adjusts the number of coil turns of the transformer according to the result of the power amplifier module, matches the output impedance of the power amplifier module with the input impedance of the loudspeaker to achieve maximum power transmission, and then outputs the signal to the loudspeaker.

Another object of the present disclosure is achieved by the following technical solutions.

An underwater acoustic communication method based on the underwater acoustic communication device having a wireless energy harvesting function is provided, including: wireless energy harvesting and power supply steps:
S1, a hydrophone receiving underwater acoustic signals, converting the underwater acoustic signals into electrical signals, and outputting the electrical signals to an on-duty circuit module;
S2, a voltage comparator in the on-duty circuit module converting sine wave signals from the hydrophone into square waves, outputting the square waves to a minimum microcontroller system, and performing frequency determination using a capture function of an internal timer of the minimum microcontroller system; when it is detected that the frequencies of the electrical signals are not the frequency of a given useful signal, the microcontroller sending no enable signal to a relay; and in this case, the relay being in an opened state, and the electrical signals from the hydrophone entering an energy harvesting module via the relay;
S3, the energy harvesting module receiving the electrical signals; a rectifier circuit converting the electrical signals from AC to DC, and then outputting the DC to a boost circuit; and the boost circuit raising a low DC voltage to a high DC voltage, and then outputting the high DC voltage to an energy storage module; and
S4, the energy storage module receiving the high DC voltage, and storing the high DC voltage in an energy storage medium; the energy storage medium outputting the energy to a voltage transformation circuit; the voltage transformation circuit adjusting a voltage value to operating voltages required by a sensor, the on-duty circuit module, a received information processing module, the minimum microcontroller system, a transmit information processing module, and a power amplifier module, respectively, and outputting the energy to the modules to provide the operating voltages;
received signal processing steps:
R1, the hydrophone receiving the underwater acoustic signals, converting the underwater acoustic signals into the electrical signals, and outputting the electrical signals to the on-duty circuit module, the electrical signals being referred to as received signals hereinafter;
R2, the voltage comparator in the on-duty circuit module converting the received signals from the hydrophone into the square waves, outputting the square waves to the minimum microcontroller system, and performing frequency determination using the capture function of the internal timer of the minimum microcontroller system; when it is detected that the frequencies of the received signals match the frequency of the given useful signal, the microcontroller sending the enable signal to the relay and a wake-up signal to the received information processing module; after receiving the enable signal, the relay being in a closed state, and a core chip in the received information processing module entering an operating state after receiving the wake-up signal; and outputting the received signals from the hydrophone to the received information processing module via the relay;
R3, an automatic gain amplification circuit in the received information processing module stably amplifying the received signals with different amplitudes to the same amplitude, and then outputting the received signals to a filter circuit; the filter circuit filtering out mixed noise of other frequencies as much as possible through band-pass filter, and outputting the received signals to a voltage follower; and the input impedance of the voltage follower being approximately infinite to provide buffer isolation, and then outputting the received signals to the minimum microcontroller system; and
R4, the minimum microcontroller system performing demodulation and analog-to-digital conversion on the received signals, and reading information carried in the received signals;
steps of detecting and reporting anomaly data:
Y1, the sensor collecting environmental data, and outputting the data to the minimum microcontroller system;
Y2, the minimum microcontroller system detecting the environmental data, and storing the environmental data in a data storage unit through an interface; when the anomaly data is detected, the minimum microcontroller system sending the wake-up signal to the transmit information processing module to make a core chip of the transmit information processing module enter the operating state and drive a signal generation sub-module in the transmit information processing module to generate a modulated signal;
Y3, the signal generation sub-module generating a modulated signal of a certain frequency, outputting the modulated signal to a filter sub-module to remove high-frequency noise, and then outputting the modulated signal to the power amplifier module;
Y4, a pre-amplification sub-module in the power amplifier module receiving the signal from the signal generation sub-module, preliminarily amplifying the signal amplitude, and outputting the signal to a power amplification sub-module; the power amplification sub-module amplifying the signal amplitude by a certain multiple, and outputting the signal to a low-pass filter sub-module; and the low-pass filter sub-module reconstructing the signal into an analog signal, and outputting the analog signal to an impedance matching circuit;
Y5, a tuning matcher in the impedance matching circuit eliminating a capacitive component of the impedance of a loudspeaker, and a transformer matching the output impedance of the power amplifier with the input impedance of the loudspeaker; the power amplifier module outputting the signal to the impedance matching circuit to reduce reactive power consumption and achieve optimal power transmission matching with the loudspeaker, and then outputting the signal to the loudspeaker; and
Y6, the loudspeaker converting the received signal into the underwater acoustic signal, and sending the underwater acoustic signal to a target node to notify the occurrence of the anomaly data.

Compared with the related art, the present disclosure has the following advantages and effects.
1. The present disclosure proposes an underwater acoustic communication device having a wireless energy harvesting function. The device can collect various non-useful signals in a water body and convert these signals into energy that may be utilized by the device. Meanwhile, it has the function of receiving and sending information, and is suitable for long-term operation underwater.
2. The present disclosure proposes an underwater acoustic communication method based on the underwater acoustic communication device. At a receiving end, the received signals can be classified through the on-duty circuit module, the non-useful signals can be converted into electrical energy that can be used by energy consumption modules of the device through the energy harvesting module and the energy storage module, and the useful signal can be processed through the received information processing module and the minimum microcontroller system. At a sending end, when the sensor detects anomaly data, it will send a signal to the target node to report the abnormal situation. This method can not only realize wireless energy harvesting, but also receive and send information, enabling the device to have strong functionality.

### BRIEF DESCRIPTION OF THE DRAWINGS

The accompanying drawings described herein are provided to further understand the present disclosure, and constitute a part of the present application. Exemplary embodiments of the present disclosure and the descriptions thereof are used for explaining the present disclosure, and do not constitute an inappropriate limitation on the present disclosure. In the drawings:

FIG. 1 is a structural block diagram of an underwater acoustic communication device having a wireless energy harvesting function according to an embodiment of the present disclosure;

FIG. 2 is an operating principle diagram of an on-duty circuit module in an underwater acoustic communication device having a wireless energy harvesting function according to an embodiment of the present disclosure;

FIG. 3 is a detailed structural block diagram of a received information processing module in an underwater acoustic communication device having a wireless energy harvesting function according to an embodiment of the present disclosure;

FIG. 4 is a detailed structural block diagram of an energy harvesting module in an underwater acoustic communication device having a wireless energy harvesting function according to an embodiment of the present disclosure;

FIG. 5 is a detailed structural block diagram of an energy storage module in an underwater acoustic communication device having a wireless energy harvesting function according to an embodiment of the present disclosure;

FIG. 6 is a flowchart of an operating method at a receiving end in an underwater acoustic communication device having a wireless energy harvesting function according to an embodiment of the present disclosure;

FIG. 7 is a detailed structural block diagram of a transmit information processing module in an underwater acoustic communication device having a wireless energy harvesting function according to an embodiment of the present disclosure;

FIG. 8 is a detailed structural block diagram of a power amplifier module in an underwater acoustic communication device having a wireless energy harvesting function according to an embodiment of the present disclosure;

FIG. 9 is a detailed structural block diagram of an impedance matching circuit module in an underwater acoustic communication device having a wireless energy harvesting function according to an embodiment of the present disclosure; and

FIG. 10 is a flowchart of an operating method at a transmitting end in an underwater acoustic communication device having a wireless energy harvesting function according to an embodiment of the present disclosure.

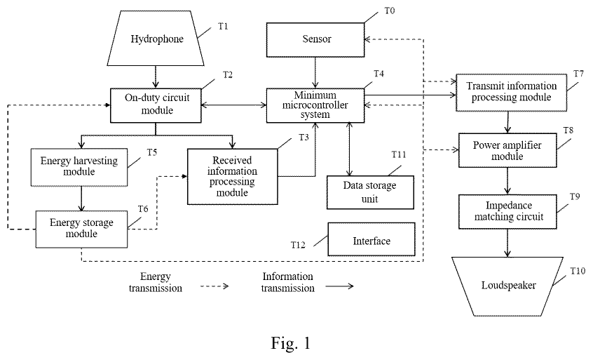

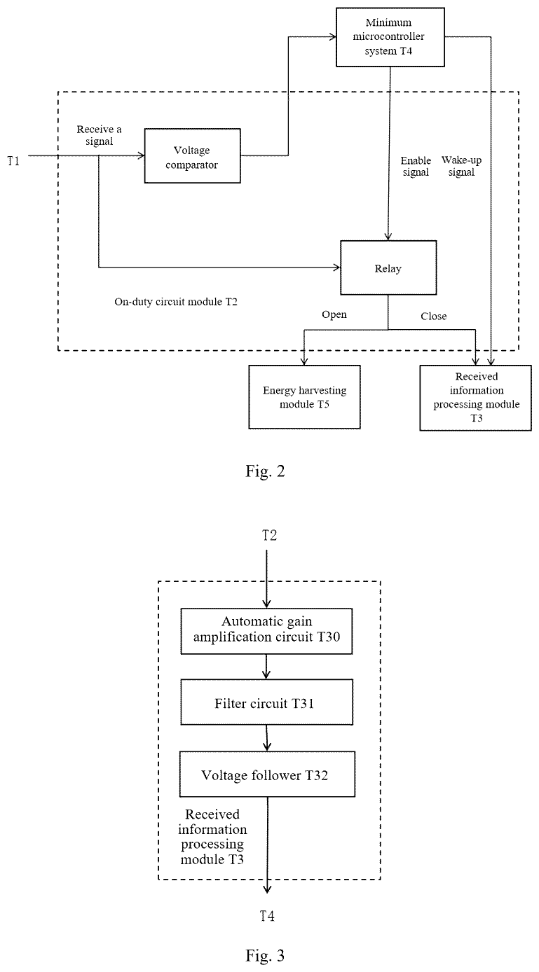

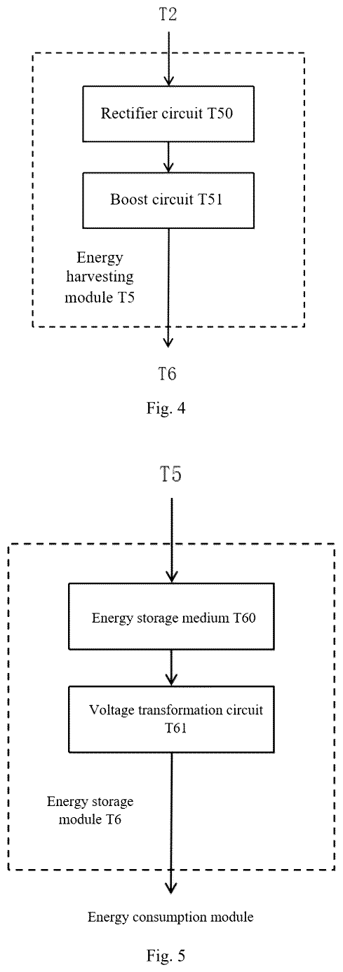

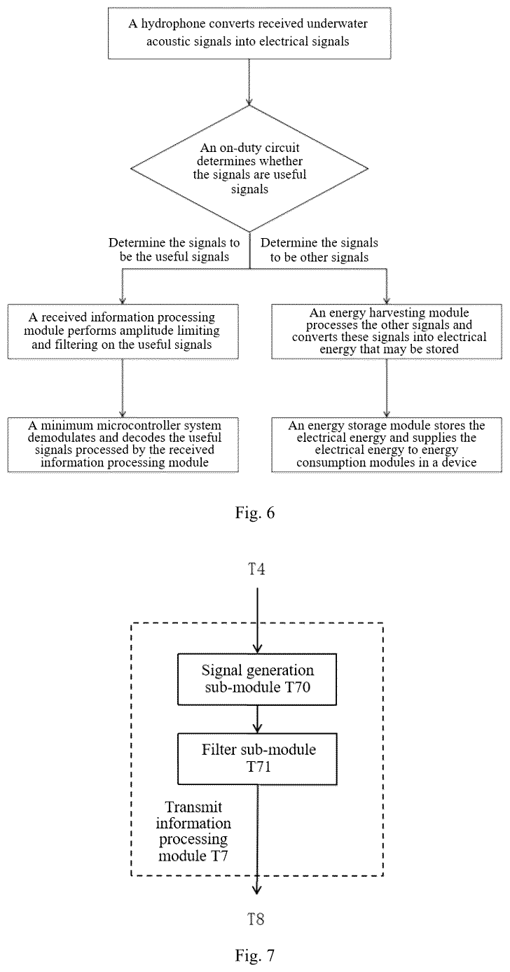

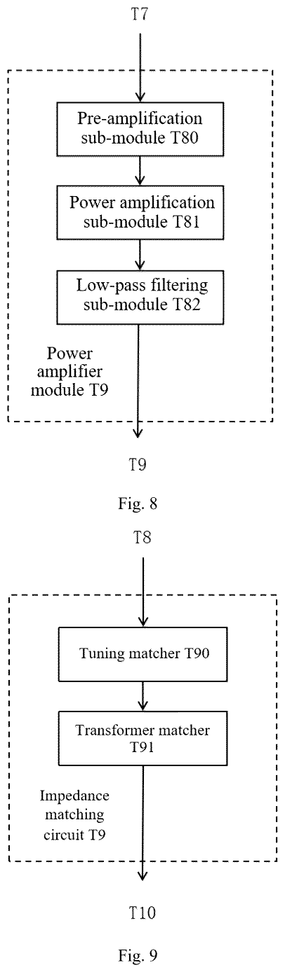

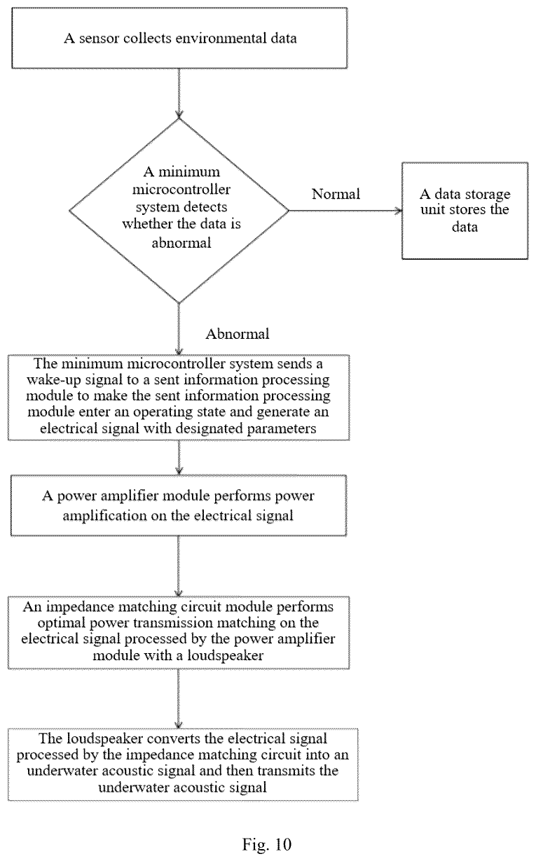

### DETAILED DESCRIPTION OF THE EMBODIMENTS

To make the objectives, technical solutions, and advantages of the embodiments of the present disclosure clearer, the technical solutions in the embodiments of the present disclosure will be clearly and completely described below in conjunction with the accompanying drawings in the embodiments of the present disclosure. Obviously, the described embodiments are merely a part of the embodiments of the present disclosure, rather than all of them. Based on the embodiments of the present disclosure, all other embodiments obtained by a person skilled in the art without making any creative effort fall within the protection scope of the present disclosure.

### Embodiment 1

Embodiment 1 discloses an underwater acoustic communication device having a wireless energy harvesting function, which adopts a hydrophone with a center frequency of 28 kHz and a frequency band range of 27-29 kHz, and approximately sets 28 kHz as an operating frequency of the whole communication system. The hydrophone collects external signals, and is connected to an on-duty circuit module.

The on-duty circuit module receives the signals from the hydrophone, cooperates with a minimum microcontroller system to perform frequency determination and channel selection on the signals, and outputs the signals to an energy harvesting module or a received information processing module.

The energy harvesting module receives the signals from the on-duty circuit module, rectifies and boosts the signals to obtain a high DC voltage, and outputs the high DC voltage to an energy storage module.

The energy storage module receives the high DC voltage from the energy harvesting module, stores electrical energy, and is connected to a sensor, the on-duty circuit module, the received information processing module, the minimum microcontroller system, a transmit information processing module, and a power amplifier module to provide operating voltages.

The received information processing module receives the signals from the on-duty circuit module, performs gain amplification and filtering on the signals, and then outputs the signals to the minimum microcontroller system.

The minimum microcontroller system includes a microcontroller, a crystal oscillator, a power supply circuit, a download circuit, and a reset circuit. The microcontroller is STM32F103ZET6, a mainstream product of STM32. The minimum microcontroller system is connected to the sensor to receive environmental data, is connected to the data storage unit for data storage and exchange, is connected to the on-duty circuit module to participate in frequency determination and channel selection of the signals, receives the signals from the received information processing module and performs demodulation and analog-to-digital conversion to interpret information, and is connected to the transmit information processing module.

The transmit information processing module receives a drive signal and a wake-up signal from the minimum microcontroller system, generates a designated transmit signal, and outputs the signal to the power amplifier module.

The power amplifier module receives the signal from the transmit information processing module, performs power amplification and filtering on the signal, and outputs the signal to an impedance matching circuit.

The impedance matching circuit receives the transmit signal from the power amplifier module, adjusts the impedance of the transmitted signal, eliminates a capacitive component, reduces reactive power loss, achieves optimal power transmission matching with the loudspeaker, and outputs the signal to the loudspeaker.

The loudspeaker is configured to transmit the signal into an external underwater acoustic environment.

In this embodiment, the on-duty circuit module includes a voltage comparator and a relay, and receives the signal from the hydrophone. The voltage comparator uses an LM393 chip to convert sine waves into square waves. The relay adopts an optocoupler isolation relay, with PC817 as the optocoupler. The closing and opening of the relay are controlled using a light-emitting diode. The on-duty circuit module is connected to the minimum microcontroller system to jointly perform frequency determination and channel selection on the signal, and outputs the signal to the energy harvesting module or the received information processing module.

In this embodiment, the received information processing module includes an automatic gain amplification circuit, a filter circuit, and a voltage follower. The automatic gain amplification circuit adopts a VCA810 chip and an INA828 instrumentation amplifier. An input end of the VCA810 chip receives the signal from the on-duty circuit module, automatically adjusts the signal gain according to the control voltage, and outputs the signal to the INA828 instrumentation amplifier to obtain a fixed gain amplification, and then outputs the signal to the filter circuit. The filter circuit adopts an MFB structure and selects an active band-pass filter with an operational amplifier RS722XK as the core. The filter circuit receives the signal from the automatic gain amplification circuit, filters out noise interference of other frequency components, and outputs the signal to the voltage follower. The voltage follower employs an operational amplifier RS721XM chip, whose input end receives the signal from the filter circuit, adjusts the matching resistance to make the output signal voltage amplitude approximately equal to the input signal voltage amplitude, and outputs the signal to the minimum microcontroller system.

In this embodiment, the energy harvesting module includes a rectifier circuit and a boost circuit, and the rectifier circuit receives the signal from the on-duty circuit. The rectifier circuit adopts a voltage doubler rectifier circuit with a BAT54S chip as the core. It converts the input AC electrical signal into a DC electrical signal and doubles the output voltage relative to the input voltage. The boost circuit uses a BQ25504 chip as the core, raises the low DC voltage outputted by the voltage doubler rectifier circuit to a high DC voltage, and outputs the high DC voltage to the energy storage module for storage.

In this embodiment, the energy storage module includes an energy storage medium and a voltage transformation circuit, and the energy storage medium receives the signal from the energy harvesting module. The energy storage medium employs a 3.7 V lithium battery, and its output end is connected to the voltage transformation circuit. The voltage transformation circuit includes a +3.7 V-to-+5 V circuit, a +5 V-to-−5 V circuit, and a +5 V-to-+3.3 V circuit, using an ME2188A50XG chip, an ICL7660SCPAZ chip, and an AMS1117-3.3 chip, respectively. An output end of the +3.7 V-to-+5 V circuit is connected to the sensor, the voltage comparator, the automatic gain amplification circuit, the filter circuit, the voltage follower, the signal generation sub-module, and the pre-amplification sub-module in the device. An output end of the +5 V-to-−5 V circuit is connected to the voltage follower and the pre-amplification sub-module in the device, both of which supply power to the +5 V dual power supply. The +5 V-to-+3.3 V circuit is connected to the minimum microcontroller system. The electrical energy outputted by the lithium battery is converted by the voltage transformation circuit to supply power to the above modules.

In this embodiment, the transmit information processing module includes a signal generation sub-module and a filter sub-module. The signal generation sub-module uses a DDS chip AD9850. The minimum microcontroller system inputs original data and the drive signal to the AD9850 chip to generate smooth, high-precision, high-resolution sine wave signals of different frequencies, and outputs the signals to the filter sub-module. In addition, the AD9850 chip receives the wake-up signal from the minimum microcontroller system, and only enters an operating state after receiving the wake-up signal, thereby saving device energy consumption. The filter sub-module uses an elliptic all-pass filter, receives the signals from the signal generation sub-module, performs all-pass filtering on the signals to improve the frequency response of the signals, and outputs the signals to the power amplifier module.

In this embodiment, the power amplifier module includes a pre-amplification sub-module, a power amplification sub-module, and a low-pass filter sub-module. The pre-amplification sub-module adopts an OP1177ARZ chip, receives the signal from the transmit information processing module, determines the amplification factor of the input signal by adjusting a resistance value in a peripheral circuit, and outputs the signal to the power amplification sub-module. The power amplification sub-module adopts an IRS2092S chip, which integrates a PWM modulator, a chip protection circuit, two external MOSFETs, and a small number of peripheral components. After receiving the signal from the pre-amplification sub-module, it amplifies the signal, converts the signal into a PWM signal, and outputs the signal to the low-pass filter sub-module. The low-pass filter sub-module uses an LC low-pass filter, reconstructs the PWM signal into an analog signal, and outputs the analog signal to the impedance matching circuit.

In this embodiment, the impedance matching circuit includes a tuning matcher and a transformer matcher. The tuning matcher adopts a series inductor structure to eliminate the capacitive component at the input end of the loudspeaker. The signal from the power amplifier module is inputted to the transformer matcher after passing the tuning matcher. A transformer core in the transformer matcher adopts the EE65 type, and the number of coil turns is adjusted according to the output impedance of the power amplifier module and the input impedance of the loudspeaker. The signal is inputted to the loudspeaker after passing the transformer matcher.

### Embodiment 2

Based on the underwater acoustic communication device having a wireless energy harvesting function disclosed in embodiment 1, this embodiment further discloses an underwater acoustic communication method based on the underwater acoustic communication device having a wireless energy harvesting function. The underwater acoustic communication method includes:
wireless energy harvesting and power supply steps:
S1, a hydrophone with a center frequency of 28 kHz receiving underwater acoustic signals, converting the underwater acoustic signals into electrical signals, and outputting the electrical signals to an on-duty circuit module;
S2, a voltage comparator in the on-duty circuit module converting sine wave signals from the hydrophone into square waves, outputting the square waves to a minimum microcontroller system, and performing frequency determination using a capture function of an internal timer of the minimum microcontroller system, a signal communication frequency between devices being set to 28 kHz; when it is detected that the frequencies of the electrical signals are not 28 kHz, the minimum microcontroller system sending no enable signal to a relay; and in this case, the relay remaining in an opened state, and the electrical signals from the hydrophone entering an energy harvesting module via the relay;
S3, the energy harvesting module receiving the electrical signals; a rectifier circuit converting the electrical signals from AC to DC, doubling the output voltage relative to the input voltage, and then outputting the DC to a boost circuit; and the boost circuit raising a low DC voltage to a high DC voltage that may charge a lithium battery, and then outputting the high DC voltage to an energy storage module; and
S4, the energy storage module receiving the high DC voltage, and storing the high DC voltage in an energy storage medium-lithium battery; the lithium battery outputting a signal with an amplitude of 3.7 V to a voltage transformation circuit; after passing a +3.7 V-to-+5 V circuit, the signal supplying power to a sensor, the voltage comparator, an automatic gain amplification circuit, a filter circuit, a voltage follower, a signal generation sub-module, and a pre-amplification sub-module in the device; after passing the +3.7 V-to-+5 V circuit and a +5 V-to-−5 V circuit, the signal supplying supply to the voltage follower and the pre-amplification sub-module, which require dual power supply; and after passing a +5 V-to-+3.3 V circuit, the signal supplying power to the minimum microcontroller system.

To fully illustrate the effect of the wireless energy harvesting function, which is the key technology of the present disclosure, the wireless energy harvesting function is verified by experiments. The experimental settings are as follows.

An energy transmitting end sends signals at a frequency of f=27 kHz to the device at different power levels, with a distance of d=100 m between them. Assuming that a spreading factor s is equal to 1.5 and a directivity coefficient DI of a transducer at the energy transmitting end is equal to 10 dB, combined with a propagation loss formula, the calculated sound pressure level (SPL) of the signal received at the device and the measured power collected by the device are as follows.

TABLE 1
Information parameter table of energy transmitting
end and device receiving end

| Transmitting power of | | Power collected |
|---|---|---|
| energy transmitting end | SPL of signal | by device |
| (Unit: W) | (Unit: dB) | (Unit: mW) |
| 10 | 161.1 | 30.3 |
| 20 | 163.1 | 32.1 |
| 30 | 164.8 | 34.3 |
| 40 | 166.1 | 36.7 |
| 50 | 167.1 | 39.5 |

Received signal processing steps are included:
R1, the hydrophone with a center frequency of 28 kHz receiving the underwater acoustic signals, converting the underwater acoustic signals into the electrical signals, and outputting the electrical signals to the on-duty circuit module, the electrical signals being referred to as received signals hereinafter;
R2, the voltage comparator in the on-duty circuit module converting the sine wave received signals from the hydrophone into square wave signals, outputting the square wave signals to the minimum microcontroller system, and performing frequency determination using the capture function of the internal timer of the minimum microcontroller system; when it is detected that the frequencies of the received signals are 28 kHz, the microcontroller sending the enable signal to the relay and a wake-up signal to the received information processing module; after receiving the enable signal, the relay being in a closed state, and the chip VCA810 in the received information processing module entering an operating state after receiving the wake-up signal; and outputting the received signals from the hydrophone to the received information processing module via the relay;
R3, an automatic gain amplification circuit in the received information processing module stably amplifying the received signals with different amplitudes to the same amplitude, which is set to 2 V in this embodiment, and then outputting the received signals to the filter circuit; the filter circuit adopting an active second-order Butterworth band-pass filter, removing mixed signals of other frequencies, properly amplifying the received signals, and then outputting the received signals to the voltage follower; and the input impedance of the voltage follower being approximately infinite to provide buffer isolation, maintaining the amplitudes of the received signals unchanged, and outputting the received signals to the minimum microcontroller system; and
R4, the minimum microcontroller system performing demodulation and analog-to-digital conversion on the received signals, and reading information carried in the received signals.

Steps of detecting and reporting anomaly data are included:
Y1, the sensor collecting environmental data, and outputting the data to the minimum microcontroller system;
Y2, the minimum microcontroller system detecting the environmental data, and storing the environmental data in a data storage unit through an interface; when the anomaly data is detected, the minimum microcontroller system sending the wake-up signal to the transmit information processing module, and the AD9850 chip in the signal generation sub-module entering the operating state after receiving the wake-up signal;
Y3, the signal generation sub-module generating a modulated signal of a certain frequency, outputting the modulated signal to a filter sub-module to remove high-frequency noise, and then outputting the modulated signal to the power amplifier module;
Y4, a pre-amplification sub-module in the power amplifier module receiving the signal from the signal generation sub-module, preliminarily amplifying the signal amplitude, and outputting the signal to a power amplification sub-module; the power amplification sub-module amplifying the signal amplitude by a certain multiple, and outputting the signal to a low-pass filter sub-module; and the low-pass filter sub-module reconstructing the signal into an analog signal, and outputting the analog signal to an impedance matching circuit;
Y5, a tuning matcher in the impedance matching circuit eliminating a capacitive component of the impedance of a loudspeaker, and a transformer matching the output impedance of the power amplifier with the input impedance of the loudspeaker; the power amplifier module outputting the signal to the impedance matching circuit to reduce reactive power consumption and achieve optimal power transmission matching with the loudspeaker, and then outputting the signal to the loudspeaker; and
Y6, the loudspeaker converting the received signal into the underwater acoustic signal, and sending the underwater acoustic signal to a target node to notify the occurrence of the anomaly data.

The foregoing embodiments represent preferred implementations of the present disclosure, but the implementations of the present disclosure are not limited thereto. Any changes, modifications, substitutions, combinations, or simplifications made without departing from the spirit and principles of the present disclosure shall be considered equivalent replacements and fall within the protection scope of the present disclosure.

1. An underwater acoustic communication device having a wireless energy harvesting function, comprising: a sensor, a data storage unit, a receiving transducer, a transmitting transducer, an on-duty circuit module, an energy harvesting module, an energy storage module, a received information processing module, a minimum microcontroller system, a transmit information processing module, a power amplifier module, an impedance matching circuit, and an interface, the receiving transducer and the transmitting transducer being hereinafter referred to as a hydrophone and a loudspeaker, respectively,
wherein the sensor collects environmental data and outputs the environmental data to the minimum microcontroller system;
the data storage unit is connected to the minimum microcontroller system for data storage and exchange;
the hydrophone collects external environmental signals and transmits the external environmental signals to the on-duty circuit module, and the on-duty circuit module is connected to the minimum microcontroller system;
the on-duty circuit module receives the signals from the hydrophone, cooperates with the minimum microcontroller system to perform frequency determination and channel selection on the signals, and outputs the signals to the energy harvesting module or the received information processing module;
the energy harvesting module receives the signals from the on-duty circuit module, rectifies and boosts the signals to obtain a high DC voltage, and outputs the high DC voltage to the energy storage module;
the energy storage module receives the high DC voltage from the energy harvesting module, stores electrical energy, and is connected to the sensor, the on-duty circuit module, the received information processing module, the minimum microcontroller system, the transmit information processing module, and the power amplifier module to provide operating voltages;
the received information processing module receives the signals from the on-duty circuit module, performs gain amplification and filtering on the signals, and then outputs the signals to the minimum microcontroller system;
the minimum microcontroller system is connected to the sensor to receive the environmental data, is connected to the data storage unit for data storage and exchange, is connected to the on-duty circuit module to participate in frequency determination and channel selection of the signals, receives the signals from the received information processing module and performs demodulation and analog-to-digital conversion to interpret information, and is connected to the transmit information processing module;
the transmit information processing module receives a drive signal and a wake-up signal from the minimum microcontroller system, generates a designated transmit signal, and outputs the signal to the power amplifier module;
the power amplifier module receives the signal from the transmit information processing module, performs power amplification and filtering on the signal, and outputs the signal to the impedance matching circuit;
the impedance matching circuit receives the transmit signal from the power amplifier module, adjusts the output impedance of the power amplifier module, eliminates a capacitive component, reduces reactive power loss, achieves optimal power transmission matching with the loudspeaker, and outputs the signal to the loudspeaker;
the loudspeaker is configured to transmit the signal into an external underwater acoustic environment;
the interface is configured to download the data stored in the data storage unit or program the minimum microcontroller system.

2. The underwater acoustic communication device having a wireless energy harvesting function according to claim 1, wherein the on-duty circuit module comprises a voltage comparator and a relay,
wherein the voltage comparator receives the signal from the hydrophone, converts the signal into a square wave, and transmits the square wave to the minimum microcontroller system;
the minimum microcontroller system receives the signal from the voltage comparator, determines the signal frequency, and determines whether to transmit an enable signal to the relay according to a result;
the relay receives the signal from the hydrophone and the enable signal from the minimum microcontroller system; when the enable signal is received, the relay closes and outputs the signal from the hydrophone to the received information processing module; and when no enable signal is received, the relay opens and outputs the signal from the hydrophone to the energy harvesting module.

3. The underwater acoustic communication device having a wireless energy harvesting function according to claim 2, wherein the received information processing module comprises an automatic gain amplification circuit, a filter circuit, and a voltage follower,
wherein the automatic gain amplification circuit receives the signal from the on-duty circuit module, amplifies an output amplitude of the signal to a fixed value, and outputs the signal to the filter circuit;
the filter circuit receives the signal from the automatic gain amplification circuit, filters out interference frequency components in the signal, and outputs the signal to the voltage follower;
the voltage follower receives the signal from the filter sub-module, acts as a buffer circuit to maintain the signal amplitude, and outputs the signal to the minimum microcontroller system.

4. The underwater acoustic communication device having a wireless energy harvesting function according to claim 3, wherein the energy harvesting module comprises a rectifier circuit and a boost circuit,
wherein the rectifier circuit receives the signal from the on-duty circuit module, converts AC electrical energy into DC electrical energy, and outputs the DC electrical energy to the boost circuit;
the boost circuit receives the DC electrical energy from the rectifier circuit, raises a low DC voltage to the high DC voltage, and outputs the high DC voltage to the energy storage module.

5. The underwater acoustic communication device having a wireless energy harvesting function according to claim 4, wherein the energy storage module comprises an energy storage medium and a voltage transformation circuit,
wherein the energy storage medium receives energy from the boost circuit for storage and outputs the energy to the voltage transformation circuit;
the voltage transformation circuit receives the energy from the energy storage medium, performs voltage transformation on the energy, and then transmits the energy to the sensor, the on-duty circuit module, the received information processing module, the minimum microcontroller system, the transmit information processing module, and the power amplifier module to provide the operating voltages.

6. The underwater acoustic communication device having a wireless energy harvesting function according to claim 5, wherein the transmit information processing module comprises a signal generation sub-module and a filter sub-module,
wherein the signal generation sub-module receives the drive signal and the data from the minimum microcontroller system, modulates the data, and outputs the data to the filter sub-module;
the filter sub-module receives the signal from the signal generation sub-module, filters the signal, and outputs the signal to the power amplifier module.

7. The underwater acoustic communication device having a wireless energy harvesting function according to claim 6, wherein the power amplifier module comprises a pre-amplification sub-module, a power amplification sub-module, and a low-pass filter sub-module,
wherein the pre-amplification sub-module receives the signal from the filter sub-module, adjusts the signal amplitude to a certain range, and outputs the signal to the power amplification sub-module;
the power amplification sub-module receives the signal from the pre-amplification sub-module, amplifies the signal power, and outputs the signal to the low-pass filter sub-module;
the low-pass filter sub-module receives the signal from the power amplification sub-module, filters the signal, and outputs the signal to the impedance matching circuit.

8. The underwater acoustic communication device having a wireless energy harvesting function according to claim 7, wherein the impedance matching circuit comprises a tuning matcher and a transformer matcher,
wherein the tuning matcher receives the signal from the low-pass filter sub-module, eliminates the capacitive component of the input impedance of the loudspeaker, and outputs the signal to the transformer matcher;
the transformer matcher receives the signal from the tuning matcher, matches the output impedance of the tuning matcher with the input impedance of the loudspeaker to achieve maximum power transmission, and outputs the signal to the loudspeaker.

9. An underwater acoustic communication method based on the underwater acoustic communication device having a wireless energy harvesting function according to claim 1, comprising:
wireless energy harvesting and power supply steps:
S1, a hydrophone receiving underwater acoustic signals, converting the underwater acoustic signals into electrical signals, and outputting the electrical signals to an on-duty circuit module;
S2, a voltage comparator in the on-duty circuit module converting the electrical signals from the hydrophone into square waves, outputting the square waves to a minimum microcontroller system, and performing frequency determination using a capture function of an internal timer of the minimum microcontroller system; when it is detected that the frequencies of the electrical signals are not the frequency of a given useful signal, the microcontroller sending no enable signal to a relay; and in this case, the relay being in an opened state, and the electrical signals from the hydrophone entering an energy harvesting module via the relay;
S3, the energy harvesting module receiving the electrical signals; a rectifier circuit converting the electrical signals from AC to DC, and then outputting the DC to a boost circuit; and the boost circuit raising a low DC voltage to a high DC voltage, and then outputting the high DC voltage to an energy storage module; and
S4, the energy storage module receiving the high DC voltage, and storing the high DC voltage in an energy storage medium; the energy storage medium outputting the energy to a voltage transformation circuit; the voltage transformation circuit adjusting a voltage value to operating voltages required by a sensor, the on-duty circuit module, a received information processing module, the minimum microcontroller system, a transmit information processing module, and a power amplifier module, respectively, and outputting the energy to the modules to provide the operating voltages;
received signal processing steps:
R1, the hydrophone receiving the underwater acoustic signals, converting the underwater acoustic signals into the electrical signals, and outputting the electrical signals to the on-duty circuit module, the electrical signals being referred to as received signals hereinafter;
R2, the voltage comparator in the on-duty circuit module converting the received signals from the hydrophone into the square waves, outputting the square waves to the minimum microcontroller system, and performing frequency determination using the capture function of the internal timer of the minimum microcontroller system; when it is detected that the frequencies of the received signals match the frequency of the given useful signal, the microcontroller sending the enable signal to the relay and a wake-up signal to the received information processing module; after receiving the enable signal, the relay being in a closed state, and a core chip in the received information processing module entering an operating state after receiving the wake-up signal; and outputting the received signals from the hydrophone to the received information processing module via the relay;
R3, an automatic gain amplification circuit in the received information processing module stably amplifying the received signals with different amplitudes to the same amplitude, and then outputting the received signals to a filter circuit; the filter circuit filtering out mixed noise of other frequencies as much as possible through band-pass filter, and outputting the received signals to a voltage follower; and the input impedance of the voltage follower being approximately infinite to provide buffer isolation, and then outputting the received signals to the minimum microcontroller system; and
R4, the minimum microcontroller system performing demodulation and analog-to-digital conversion on the received signals, and reading information carried in the received signals;
steps of detecting and reporting anomaly data:
Y1, the sensor collecting environmental data, and outputting the data to the minimum microcontroller system;
Y2, the minimum microcontroller system detecting the environmental data, and storing the environmental data in a data storage unit through an interface; when the anomaly data is detected, the minimum microcontroller system sending the wake-up signal to the transmit information processing module to make a core chip of the transmit information processing module enter the operating state and drive a signal generation sub-module in the transmit information processing module to generate a modulated signal;
Y3, the signal generation sub-module generating a modulated signal of a certain frequency, outputting the modulated signal to a filter sub-module to remove high-frequency noise, and then outputting the modulated signal to the power amplifier module;
Y4, a pre-amplification sub-module in the power amplifier module receiving the signal from the signal generation sub-module, preliminarily amplifying the signal amplitude, and outputting the signal to a power amplification sub-module; the power amplification sub-module amplifying the signal amplitude by a certain multiple, and outputting the signal to a low-pass filter sub-module; and the low-pass filter sub-module reconstructing the signal into an analog signal, and outputting the analog signal to an impedance matching circuit;
Y5, a tuning matcher in the impedance matching circuit eliminating a capacitive component of the impedance of a loudspeaker, and a transformer matcher adjusting a resistance value; and the power amplifier module outputting the signal to the impedance matching circuit to achieve optimal power transmission matching with the loudspeaker, and outputting the signal to the loudspeaker; and
Y6, the loudspeaker converting the signal into the underwater acoustic signal, and sending the underwater acoustic signal to a target node to notify the occurrence of the anomaly data.
